(19) United States
(12) Patent Application Publication
(10) Pub. No.: US 2014/0321119 A1
(43) Pub. Date: Oct. 30, 2014

(54) ELECTRIC CANDLE

(71) Applicant: GMS GmbH, Dortmund (DE)

(72) Inventor: Joern Gaumann, Dortmund (DE)

(21) Appl. No.: 14/363,397

(22) PCT Filed: Sep. 20, 2012
(86) PCT No.: PCT/EP2012/068496

§ 371 Date: Jun. 6, 2014

(30) Foreign Application Priority Data
Dec. 23, 2011 (DE) 20 2011 052 464.7

(51) Int. Cl. F21V 35/00; F21S 10/04; F21S 6/00; F21K 99/00

(52) U.S. Cl. CPC F21V 35/00; F21K 9/1355; F21S 10/04; F21S 6/001
USPC 362/249.02; 362/249.01

(57) ABSTRACT

The invention relates to an electric candle (1), comprising a candle body (2) and at least one luminous means (16). In order to technically develop the electric candle (1) further in such a way, the invention proposes that the candle body (2) is at least partly composted of a gel (10).

The invention relates to an electric candle, having a candle body and at least one lighting means.

Electric candles of the type stated initially are sufficiently known and have at least one electrically operated lighting means that is generally integrated into the candle body. The candle body is formed of wax, plastic or another translucent material, for example. The lighting means integrated into the candle body illuminates the candle body from the inside in one variant.

In a further variant of the candle of the type stated initially, the lighting means is disposed in the interior of the candle body in such a manner that the light beams are emitted into a flame-shaped structure that is situated on the upper face-side end of the candle and is produced by means of a translucent or transparent material. In this way, the appearance of a flame of a conventional candle is simulated when electricity is supplied. In this connection, the internal structure of the previously known electric candle is structured, in the simplest case, in such a manner that the lighting means is connected with an electricity source, which is configured as a battery or rechargeable battery, for example, by way of lines and a switch.

The development and further development of electric candles is based on the recognition that burning down of candles continues to be a possible cause of fire damage.

Electric candles represent a proven instrument for preventing fire damage caused by improper use by the consumer. Of course, a prerequisite for this is that electric candles find increased acceptance among consumers. This acceptance among consumers is achieved, last but not least, by the esthetic appearance of electric candles, which reproduces the appearance of conventional candles with their light effects.

It is therefore the task of the present invention to technically develop an electric candle of the type stated initially further, in such a manner that a more pleasing esthetic perception by the consumer is achieved.

This task is accomplished with the characteristics of claim 1. Advantageous embodiments of the invention are evident from the dependent claims.

The invention is characterized in that the candle body is composed, at least in part, of a gel.

The core idea of the invention is to combine components of electric candles and gel candles with one another.

Aside from conventional candles made of wax, which can be substituted with electric candles, conventional gel candles are also sufficiently known. In this connection, combustible gel that is situated in a container is burned by way of a wick set into it. The transparency of the combustible material and the esthetic characteristics of gel candles lead to acceptance by the consumer.

An additional effect is created by the gel in the candle body, which gel is preferably present as gel wax, and this effect leads to greater esthetic perception and thereby to greater acceptance by more than a few consumers. In this connection, the gel can be structured in different colors. Gel formation advantageously takes place in such a manner that a vessel in which a housing for the electrical part of the candle according to the invention is preferably already situated is filled with liquid gel, which then cools and becomes solid (elastic).

A further advantage of the invention can also be seen in that gel candles, which are very popular, are protected from burning off or being consumed rapidly, by means of the artificial lighting.

Negative characteristics of a gel candle, such as consumption of the gel or an increased risk of fire caused by the open flame, are thereby avoided by means of the invention.

In this connection, an advantageous embodiment of the invention provides that the lighting means is an LED. A long period of operation of the electric candle is guaranteed by an LED.

According to a practicable variant of the invention, a container that surrounds the candle body is assigned to the candle body. A container, preferably made of glass, represents a proven instrument for accommodating the gel mass.

In the following, the invention will be explained in greater detail using the drawings. These show, in a schematic representation:

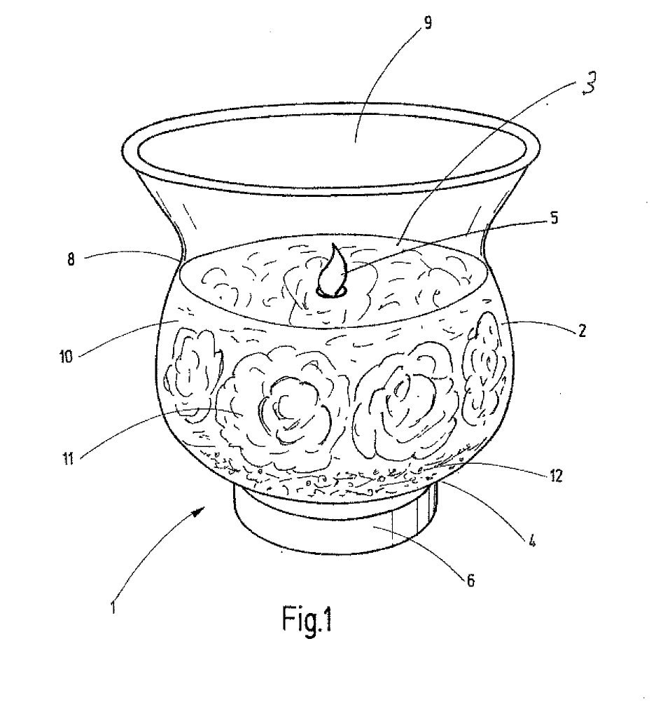

FIG. 1 a perspective view of an electric candle according to the invention,

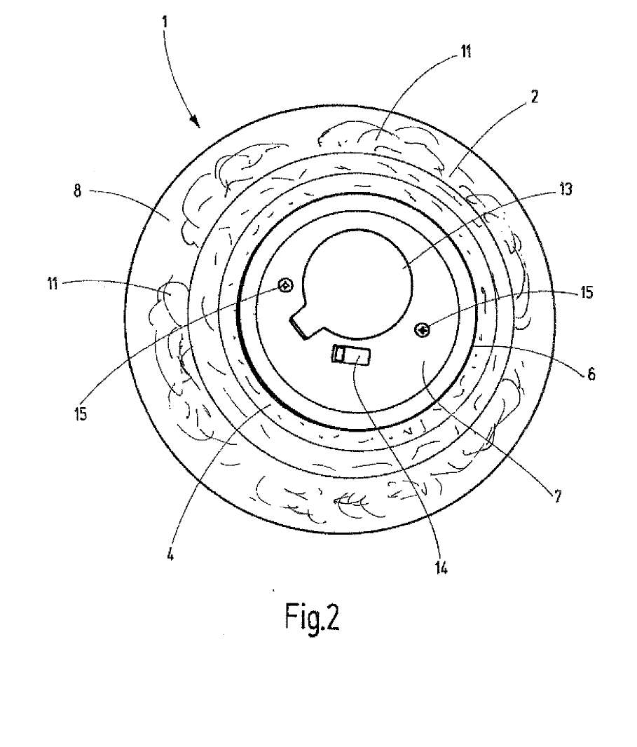

FIG. 2 a view from below of the candle from FIG. 1, and

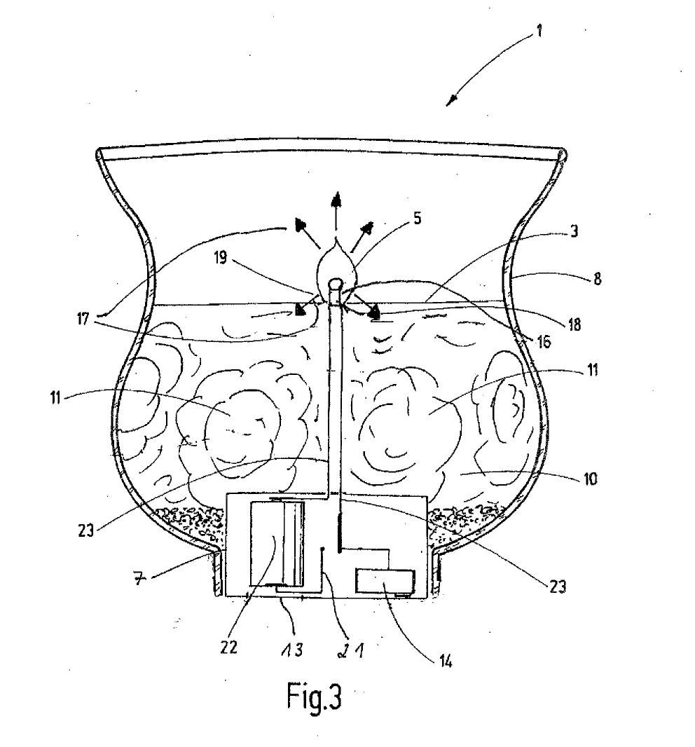

FIG. 3 a longitudinal section through the electric candle according to the invention.

FIG. 1 shows an electric candle that is provided with the reference symbol 1.

The electric candle 1 comprises a candle body 2 that has an upper face-side end 3 and a lower face-side end 4, as also illustrated in FIG. 1. The candle body 2 is formed from a gel and is enclosed by a container 8.

On the upper face-side end 3 of the candle body 2, a flame-shaped structure 5 composed of a transparent or translucent material extends upward; it simulates a conventional flame, so that here, too, the external look of a conventional candle flame exists. In an alternative embodiment, the flame-shaped structure 5 can also project into the upper face-side end 3 of the candle body 2. In a further embodiment of the invention, not shown in FIGS. 1 to 3, the flame-shaped structure 5 can enclose a candle wick that can be illuminated and is formed from a transparent or translucent material. An electric candle equipped with such a candle wick is disclosed in the German utility model 20 2011 106 610.3.

A container 8 made of glass is assigned to the candle body 2, enclosing the candle body 2. In the embodiment shown, the container 8 and the candle body 2 are bellied in the embodiment shown, i.e. they first widen, proceeding from the upper face-side end 3, and finally assume a smaller diameter again toward the lower face-side end 4. Above the upper face-side end 3, ₜhe bellied container 8 widens. At its upper and lower end, the container 8 has an opening 9, in each instance. The container 8 ends with a base 6, which, as is evident from FIG. 2, is an integral part of the housing 7 for accommodation of the electrical circuit and the power supply. The housing 7 sits within the lower opening 9.

Decorative material 11 is disposed within the gel 10; in the embodiment shown in FIG. 1, it is present in the form of flowers and is of natural and/or artificial origin. In order to structure the transition between the base 6 and the gel 10 more attractively, fill material 12 in the form of granulate of different sizes and colors is additionally filled into the gel 10. Within the scope of production of the candle body 2, the gel 10 is filled onto the fill material 12, so that the fill material 12 has a certain minimal freedom of movement and is not fixed in place.

As is evident from FIG. 2, the housing 7 is an integral part of the base 6 of the container 8 and projects into the container 8, as illustrated in FIG. 3. The housing 7 has a switch 14 as well as fastening means 15 at its lower end, i.e. the end facing away from the candle body 2. The fastening means 15 connect the releasable lower end of the housing 7 with the housing 7. Furthermore, the housing 7 is provided with a battery compartment, which can be closed off with the battery compartment cover 13, at its lower end. The battery compartment opening or the battery compartment cover 13 serves for insertion of a power supply 22 shown in FIG. 3, in the form of a battery, in order to guarantee a supply of electricity to the electric candle 1.

Within the flame-shaped structure 5, i.e. directly above the candle body 2, there is, as illustrated in FIG. 3, the lighting means 16 that emits light beams 17 through the flame-shaped structure 5, upward and downward, into the candle body 2. In a further advantageous embodiment, a second lighting means 16, not shown in FIGS. 1 to 3, is situated centered above the fill material 12 and additionally illuminates the decorative material 11.

In the interior of the candle body 2, there is a circuit 21 that is formed from at least one lighting means 16, the power supply 22, which is present as a battery in the embodiment shown in FIG. 3, as well as the switch 14, situated within the housing 7. The lighting means 16 is supplied with electricity by way of the lines 23.

In the embodiment of the electric candle 1 according to the invention shown in FIG. 3, the flame-shaped structure 5 is disposed on the upper face-side end 3. The opening 18 through which the lines 23 of the circuit 21 get to the lighting means 22 from the housing 7, through the candle body 2 into the interior of the flame-shaped structure 5 configured as a hollow body, is situated on the underside of this end.

The present invention is not restricted, in terms of its embodiment, to the exemplary embodiment indicated above. Instead, a number of variants is possible, which make use of the solution presented also in embodiments that are of a different type.

For example, different glass shapes, sizes, and colors are possible. Also, the number, type, and color of the lighting means 16 can vary. Furthermore, a rechargeable battery can replace the battery. Furthermore, the electric candle 1 can also be equipped with a remote control and a timer function that guarantees that the electric candle 1 is automatically shut off after a certain time and turned on again. Finally, the container 8 can also be formed from a transparent and/or translucent plastic. The number, size, color, and type of the decorative material 11 and of the fill material 12 can vary.

### Reference Symbol List

1 candle
2 candle body
3 upper face-side end
4 lower face-side end
5 flame-shaped structure
6 base
7 housing
8 container
9 opening
10 gel
11 decorative material
12 fill material
13 battery compartment cover
14 switch
15 fastening material
16 lighting means
17 light beams
18 opening
19 the interior
21 circuit
22 power supply
23 lines

1. Electric candle (1), having a candle body (2) and at least one lighting means (16),
wherein
the candle body (2) is composed, at least in part, of a gel (10).

2. Candle according to claim 1,
wherein
the gel (10) is a gel wax.

3. Candle according to claim 1,
wherein
a container (8) that encloses the candle body (2) is assigned to the candle body (2).

4. Candle according to claim 1,
wherein
the candle body (2) has a flame-shaped structure (5) that is formed from a transparent or at least translucent material.

5. Candle according to claim 3,
wherein
the container (8) is made of glass or a transparent plastic.

6. Candle according to claim 1,
wherein
the lighting means (16) is a light-emitting diode.

7. Candle according to claim 4,
wherein
the flame-shaped structure (5) projects into an upper face-side end (3) of the candle body (2).

8. Candle according to claim 4,
wherein
the flame-shaped structure is disposed on the upper face-side end (3) of the candle body (2).

9. Candle according to claim 4,
wherein
the lighting means (16) is disposed within the candle body (2) and/or within the flame-shaped structure (5).

10. Candle according to claim 3,
wherein
the container (8) has an opening (9) at its upper and/or lower end.

11. Candle according to claim 1,
wherein
decorative material (11) is disposed within the gel (10).

12. Candle according to claim 1,
wherein
the gel (10) is provided with fill material (12).

13. Candle according to claim 1,
wherein
an electrical part is accommodated within the candle body (2).

14. Candle according to claim 13,
wherein
a housing (7) surrounds the electrical part.
